(19) United States
(12) Patent Application Publication
(10) Pub. No.: US 2006/0146100 A1
(43) Pub. Date: Jul. 6, 2006

(54) Ink jet supply component including a secure memory serial device

(76) Inventors: Daniel J. Dull, San Diego, CA (US); Stephen E. Sullivan, Irvine, CA (US); Steve Inderieden, San Diego, CA (US)

Correspondence Address: Mark G. Bocchetti;Patent Legal Staff, Eastman Kodak Company, 343 State Street, Rochester, NY, 14650-2201, US

(21) Appl. No.: 11/029,245

(22) Filed: Jan. 4, 2005

(51) Int. Cl. B41J 2/175

(52) U.S. Cl. 347/85

(57) ABSTRACT

The embodied systems are used to manage consumables used in an ink jet print system and to prevent use of unauthorized printheads or unauthorized ink supply containers in an ink jet printing system. The embodiments are used on typical ink jet printing systems that include a printhead, an ink supply container, a carriage board in communication with the printhead, and a main board in communication with the ink supply container and the carriage board. The novel systems include a serial device disposed on the printhead or the ink supply container having a unique signature which is then authenticated by firmware and hardware of the printing system.

### FIELD OF THE INVENTION

The present embodiments relate generally a serial device disposed on the printhead or an ink supply container of a typical ink jet print system to manage consumable use and control unauthorized use of ink supply containers and printheads.

### BACKGROUND OF THE INVENTION

Current ink jet printing systems consist of a fluid system supporting one or more printheads. Typical ink jet printheads operate by forcing fluid through a droplet generator that contains an array of orifices, forming droplets of ink. The type of ink used in the printhead is important; the type of ink used will enhance overall reliability of the system or cause the printhead to fail.

In ink jet printing systems, ink parameters are finely tuned to work in conjunction with the printhead portion of the system. The use of an ink that is not certified to work with a particular system can adversely affect the quality of printing, the frequency of print systems errors, and/or the longevity of print system components.

Since a printhead may be considered a high cost consumable element in the printing system, it is often warranted by the manufacturer to meet certain reliability criteria and, therefore, the manufacturer often ends up absorbing the large cost of a customer's use of non-approved ink in a print system. This is an expense that manufacturers desire to avoid.

Typically, the customer purchases the system with the agreement that the customer must use approved ink. For various reason (i.e., low cost, better short term performance at the expense of reduced printhead life, availability of a specific color, and the like) a customer may be tempted to use non-approved ink.

A need exists for a method to track the consumption of ink or other fluids by an ink jet printing system. If non-approved ink is being used by the customer, a need exists for a method to let the manufacturer know that the conditions of the warranty have been violated.

Hillmann et al. U.S. Pat. No. 5,365,312 discloses a technique for tracking the use of replaceable ink reservoirs, toner cartridges, and ribbon cassettes by permanently modifying the electronic memory associated with these devices. A drop counting technique is used to determine usage and misusage of ink.

Other systems for detecting ink cartridge status are known in the art, as exampled by Hilton et al. U.S. Pat. No. 6,158,837; Lefebvre et al. U.S. Pat. No. 6,116,715; and Lee U.S. Pat. No. 6,062,669. The prior art listed herein is hereby incorporated by reference.

The present invention prevent the unauthorized use of printhead and ink supply containers that do not meet the specification of the ink jet printing system by using a unique signature and generation of an authentication code for usage of ink supply containers and printheads.

### SUMMARY OF THE INVENTION

Embodied herein is an ink jet printing system. The ink jet system includes a printhead, an ink supply container, a carriage board in communication with the printhead, and a main board in communication with the ink supply container and the carriage board. The system further includes a serial device disposed on the printhead or the ink supply container having a unique signature. The serial device includes a memory area, a secure hash engine, and a pulsed bus comprising a bidirectional port. The secure hash engine generates an authentication code from the unique signature and communicates the code to the firmware and hardware of the printing system to ensure only authorized printheads and ink supply containers are used in the system.

The embodied systems can be used in various methods to both manage consumables used in an ink jet print system and prevent unauthorized duplication and use of printheads and ink supply containers with an ink jet print system.

The present embodiments are advantageous over the prior art because the methods provide better security than known systems and methods.

### BRIEF DESCRIPTION OF THE DRAWINGS

In the detailed description of the preferred embodiments presented below, reference is made to the accompanying drawings, in which:

FIG. 1 is a block diagram of a typical ink jet printer system usable with this invention.

FIG. 2 is a block diagram of an embodiment of a serial device usable with the typical ink jet printer system.

FIG. 3 is a block diagram of an embodiment of a secure hash engine usable with the invention.

FIG. 4 is an embodiment of FIG. 1 depicting six ink containers, six printheads, and twelve serial devices.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The present embodiments relate to a system for managing print quality for printheads.

The embodiments include methods for controlling fraud resulting from people attempting to duplicate a manufacturer's printhead or ink supply container.

These embodiments have a benefit of reducing environmental harm by ensuring that ink that is not out of compliance for an ink jet print system. For example, the ink supply container pressure is important to the printing system. When the wrong pressure ink supply container is used, the wrong pressure is applied to the system, thereby resulting in leakage due to improper regulation of this pressure. Ink leakage can result in a short in the system and cause damage. If a highly volatile ink is wrongfully used in the system, the volatile solvent can ignite. These methods with serial devices prevent these types of harm and result in a safer working environment with less down time for the equipment. Further, the methods provide a longer life to the print systems, which is environmentally useful.

The present embodiments ensure that the right type of ink is used with the right kind of paper which reduces waste from improper use and results in poor imaging.

The embodied methods provide the advantage of ensuring that the printing system operates safely. For example, if the wrong electrical applications are applied to a printhead due to a counterfeit printhead, the printing system can catch fire. The embodied methods prevent this possibility.

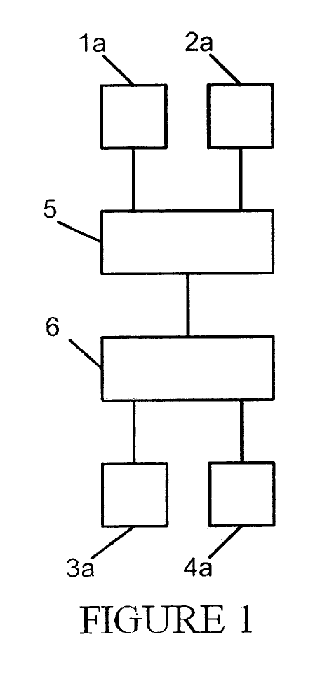

With reference to the figures, FIG. 1 depicts a block diagram of a typical ink jet printer system. The ink jet printing system includes one or more printheads 1a and 2a, one or more ink supply containers or bottles 3a and 4a, and a carriage board 5 that operates the moveable carriage of the printing system. The carriage board 5 is in communication with the printheads 1a and 2a and a main board 6. FIG. 1 depicts and embodiment of two printheads 1a and 2a and two ink supply containers 3a and 4a; however more than two printheads and more than two ink supply containers or bottles can be used. The main board 6 is in communication with the ink supply containers 3a and 4a. This present embodiments work particularly well on an Encad model Novajet™ 1000i ink jet printing system with six printheads, available from Encad™ of San Diego, Calif. The preferred ink is a water-based ink, such as a Qi Dye water based ink available from Encad™ of San Diego.

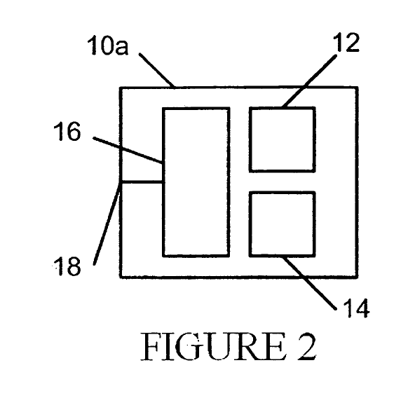

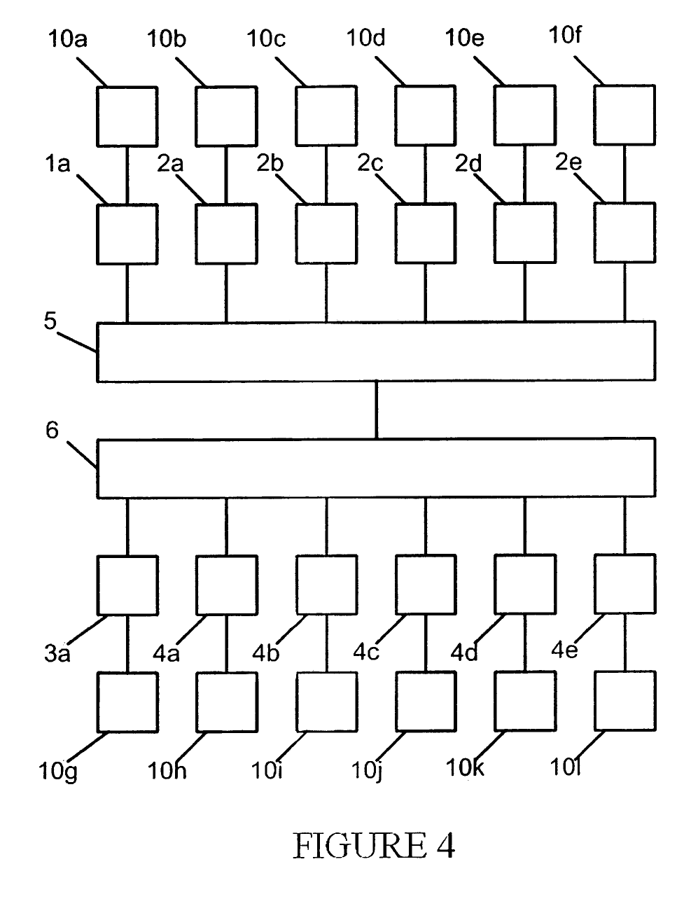

A serial device 10a usable in these embodiments is depicted in block diagram format in FIG. 2. One serial device can be disposed on each printhead 1a and 2a and/or on each ink supply container 3a and 4a. For example, in the embodiment depicted in FIG. 4, the ink jet printing system includes six printheads 1a, 2a, 2b, 2c, 2d, and 2e connected to the carriage board 5, and six ink containers 3a, 4a, 4b, 4c, 4d, and 4e connected to the main board 6. A serial device 10a, 10b, 10c, 10d, 10e, 10f, 10g, 10h, 10i, 10j, 10k and 10l is installed on each printhead 1a, 2a, 2b, 2c, 2d, and 2e and each ink container 3a, 4a, 4b, 4c, 4d, and 4e. Other embodiments can include ink jet systems with one printhead and multiple ink containers or an embodiment of one ink container and multiple printheads.

Returning to FIG. 2, each serial device 10 has a memory area 12 that contains between 256 bits and 8192 bits of memory, and more preferably 1024 bits of memory.

Each serial device 10 further includes a secure hash engine 14 and a pulsed bus 16. The pulsed bus 16 includes a bidirectional port 18.

The memory area 12 is typically a non volatile memory area. The memory area 12 stores data, such as (a) consumable type information, (b) ink type information, (c) ink color information, (d) original equipment manufacturer information, (e) printhead TSR values, (f) ink usage, (g) a unique signature, and (h) combinations of this data.

Consumable type information is typically information on a consumable, such as ink supply container or printhead. The consumable type information can include a field that can be used to indicate that the serial device has not been programmed.

The ink type information stored in the memory area 12 of the serial device 10 designates the ink as either dye based or pigment based. An example of a dye based ink is an Encad Qi Dye black water based ink available from Encad of San Diego. An example of a pigment based ink is Qi Pigment cyan water based ink available from Encad.

The ink color information is typically data associated with a color, such as cyan, magenta, black, yellow, light cyan, or light magenta. New colors can be added to the ink color information other than these listed as printers become more versatile, such as red or blue.

The original equipment manufacturer information stored in the memory area 12 of the serial device 10 can include consumable compatibility information, specific manufacturer's names, or combinations thereof. Examples of consumable compatibility information include a manufacture year, a manufacture week, a manufacture location, or combinations of this information. Examples of a specific manufacturer's name could be Kodak™ or Encad™ or combinations of manufacturer's or even distributor's names.

The printhead temperature sensing resistor value (TSR value) can be a predetermined calibration value based on a reference temperature. An example of a TSR value can be a resistance of 400 ohms with a reference temperature of about 25 degrees Celsius.

The ink usage value stored in the memory area 12 of the serial device 10 is an indicator of an amount of ink that has been printed by the printhead or an indicator of an amount of ink that has been used from the ink supply container. For example, an indicator of an amount of ink that has been printed could be 600 ml on the Novajet 1000i™ printing system. An indicator of an amount of ink that has been used from the ink supply container can be expressed in the same way, such as 450 ml.

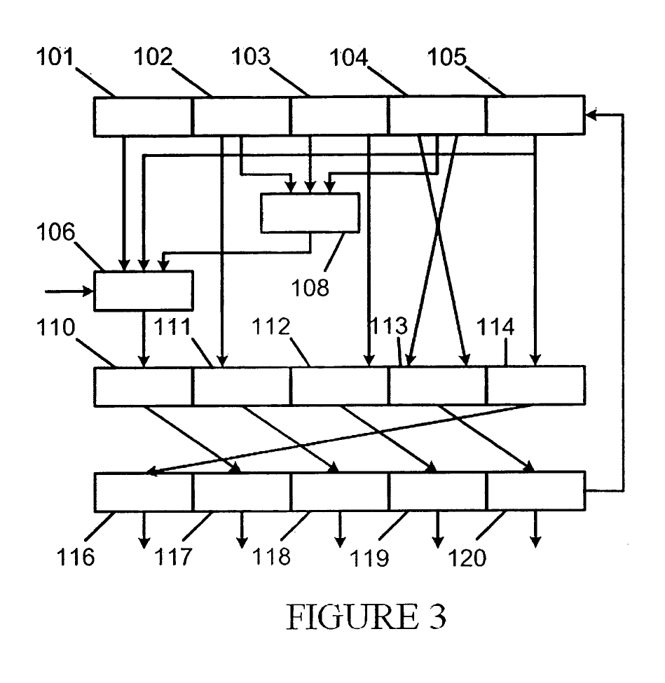

The serial device 10 includes a secure hash engine 14. The secure hash engine 14 is depicted in a block diagram in FIG. 3. The purpose of the hash engine 14 is to generate the authentication code that is used to validate an ink supply container or printhead. An example of the code is a twenty-byte sequence.

The secure hash engine 14 includes an adder 106, a multiplier 108, and a first register set 101, 102, 103, 104, and 105. The adder 106 acts on a portion of the first register set 101, 102, 103, 104, and 105 forming summations. The multiplier 108 acts on a portion of the first register set 101, 102, 103, 104, and 105 forms products. The multiplier 108 and the adder 106 do not have to work on the same portions of the first register set 101, 102, 103, 104, and 105. The portions can be exclusive of one another, can overlap one another, or can include the same values.

A second register set 110, 111, 112, 113, and 114 is formed from the portions of the first register set 101, 102, 103, 104, and 105, summations from the adder 106, and products from the multiplier 108.

A third register set 116, 117, 118, 119, and 120 is produced by rotating the second register set 110, 111, 112, 113, and 114 by a bit shift. The bit shift can be a single bit shift, or a shift by a plurality of bits, such as between 2 bits and 25 bits.

The third register set 116, 117, 118, 119, and 120 then transfers to the first register set 101, 102, 103, 104, and 105. The transfer can occur between 60 times to 120 times, preferably 80 times. Each register set comprises a size from 32 bits to 64 bits.

The unique signature that is encoded on the serial device 10 is preferably an 8-byte numerical sequence that is used by the secure hash engine 14 to create the authentication code.

Returning to FIG. 2, the serial device 10 includes a pulsed bus 16. The purpose of the pulsed bus 16 is to provide means for communicating with the serial device 10. The pulsed bus 16 is an integral part of the serial device.

The pulsed bus 16 can be a single wire bidirectional bus in one embodiment. Other embodiments can use a dual wire or multiple wire bidirectional bus.

The pulsed bus 16 includes a long pulse and a short pulse. The long pulse is longer than 60 microseconds. The short pulse is less than about 15 microseconds. Each pulse defines a bit. Preferably, the long pulse is at least twice as long as the short pulse.

The pulsed bus 16 operates at a minimum of two speeds: a regular speed and a high speed. The high speed is typically ten times faster than the regular speed. Each pulse used in the high speed is scaled down in comparison to the pulses used at regular speed. Each pulse in high speed is produced faster than an equivalent pulse produced at regular speed. When there is no pulse, the pulsed bus 16 is at an idle state.

In an alternative embodiment, the system can include a pull-up resister associated with each printhead and/or ink supply container. The pull-up resistor is used to control the operating voltage on the pulsed bus. The pull-up resistor keeps the pulsed bus at a logic high when the pulsed bus is at an idle state.

In another alternative embodiment, the printing system can include a field programmable gate array (FPGA) controller located on the moveable carriage of the printing system. The FPGA controller enables the carriage board to authenticate the serial device and controls flow of data to the printhead. The FPGA controller retrieves the authentication code and compares the authentication code to a pre-computed authentication code to see if the two match. If a match exists, the serial device is authenticated and the possibility of using a counterfeit device is controlled.

The embodied system can be used to manage consumables in an ink jet print system. The method involves managing the consumables by first encoding a serial device 10 for a printhead with a unique signature. The unique signature is typically an 8-byte numerical sequence known only to the manufacturer that is used by the secure hash engine to calculate an authentication code.

The serial device is initialized to include specific facility and/or ink jet print system information, such as consumable type information, ink type information, ink color information, original equipment manufacturer information, printhead TSR values, ink usage, and combinations thereof.

Next, the printhead is delivered to a customer's facility. Periodically, the hardware and firmware within the ink jet print system communicates with the serial device located on the printhead or ink supply container while at the customer's facility. This periodic communication tracks ink consumption through the printhead. The serial device is typically contacted using a single wire bidirectional bus.

Ink consumption levels are tracked and compared to a first threshold level. The ink levels are tracked by counting the number of ink drops used by the printing system. The ink drops are counted by the firmware and/or hardware (FPGA) installed on the ink jet printing system. The firmware can be used to update the ink usage count in the serial device. A first threshold level is set at a warranty ink usage level, such as 700 ml. The first threshold level is set in the firmware and cannot be changed manually without replacing the firmware with a version that incorporates a new warranty threshold level.

Alternatively, the method can be used to prevent unauthorized duplication and use of an ink jet printing system. In this alternative, the method includes the step of authenticating the serial device by verifying the unique signature of the serial device using hardware and firmware within the ink jet printing system. The purpose of this step is to ensure through authentication that the ink supply container and printhead are legitimate, authorized consumable elements.

In both embodiments, the methods include providing a first message to an operator at the customer's facility when the first threshold level is reached. The message can be conveyed by an audible alarm or a text message on the ink jet print system operator display.

The method can include providing a second message to the operator when a second threshold level is reached. The second threshold level typically indicates that the operator should replace the printhead.

The invention has been described in detail with particular reference to certain preferred embodiments thereof, but it will be understood that variations and modifications can be effected within the spirit and scope of the invention.

### PARTS LIST

1a. printhead
2a. printhead
2b. printhead
2c. printhead
2d. printhead
2e. printhead
3a. ink supply container
4a. ink supply container
4b. ink supply container
4c. ink supply container
4d. ink supply container
4e. ink supply container
5. carriage board
6. main board
10a. serial device
10b. serial device
10c. serial device
10d. serial device
10e. serial device
10f. serial device
10g. serial device
10h. serial device
10i. serial device
10j. serial device
10k. serial device
10l. serial device
12. memory area
14. secure hash engine
16. pulsed bus
18. bidirectional port
101. first register set
102. first register
103. first register
104. first register
105. first register
106. adder
108. multiplier
110. second register
111. second register
112. second register
113. second register
114. second register
116. third register
117. third register
118. third register
119. third register
120. third register

1. An ink jet printing system comprising a printhead (1a and 2a), an ink supply container (3a and 4a), a carriage board (5) in communication with the printhead (1a and 2a), and a main board (6) in communication with the ink supply container (3a and 4a) and the carriage board (6), wherein the system further comprises:
a serial device (10a) disposed on the printhead (1a and 2a) or the ink supply container (3a and 4a), wherein the serial device (10a) comprises:
a. a memory area (12) with a unique signature;
b. a secure hash engine (14) adapted to generate an authentication code from the unique signature; and
c. a pulsed bus (16) comprising a bidirectional port.

2. The system of claim 1, further comprising a pull up resistor disposed on the pulsed bus for each printhead.

3. The system of claim 1, further comprising a pull up resistor disposed on the pulsed bus for each ink supply container.

4. The system of claim 1, further comprising a field programmable gate array controller on the carriage board, wherein the gate array controller is adapted to enable the carriage board to authenticate the serial device and stop flow of data to the printhead.

5. The system of claim 1, further comprising a field programmable gate array controller on the main board, wherein the gate array controller is adapted to enable the main board to authenticate the serial device and stop flow of data to the printhead.

6. The system of claim 1, wherein a first serial device is disposed on the printhead and a second serial device is disposed on the ink supply container.

7. The system of claim 1, where the serial device is a memory device comprising between 256 bits and 8192 bits of memory.

8. The system of claim 7, wherein the serial device is a memory device comprising 1024 bits.

9. The system of claim 1 wherein the memory area is a non volatile memory area.

10. The system of claim 1, wherein the memory area stores data selected from the group consisting of consumable type information, ink type information, ink color information, original equipment manufacturer information, printhead TSR value, ink usage, and combinations thereof.

11. The system of claim 10, wherein the consumable type information is information on a consumable on which the serial device is installed, an indicator that the serial device has not been programmed, or combinations thereof.

12. The system of claim 10, wherein the ink type information is a designation of ink as dye based or pigment based.

13. The system of claim 10, wherein the ink color information is cyan, magenta, black, yellow, light cyan, light magenta or another color.

14. The system of claim 10, wherein the original equipment manufacturer information is consumable compatibility information, specific manufacturer's names, or combinations thereof.

15. The system of claim 14, wherein the consumable compatibility information is a manufacture year, a manufacture week, a manufacture location, or combinations thereof.

16. The system of claim 10, wherein the printhead TSR value is a predetermined calibration value based on a reference temperature.

17. The system of claim 10, wherein the ink usage value is an indicator of an amount of ink that has been printed by the printhead or an indicator of an amount of ink that has been used from the ink supply container.

18. The system of claim 1, wherein the secure hash engine comprises:
a. a first register set;
b. an adder adapted to act on a portion of the first register set, thereby forming summations;
c. a multiplier adapted to act on a second portion of the first register set, thereby forming products;
d. a second register set produced from portions of the first register set, summations, and products; and
e. a third register set produced by rotating the second register set by at least one bit shift, and wherein the third register set transfers a plurality of times to become the first register set.

19. The system of claim 18, wherein each register set comprises a size from 32 bits to 64 bits.

20. The system of claim 18, wherein the plurality of times the third set register set becomes the first register set ranges from between 60 times to 120 times.

21. The system of claim 18, wherein the plurality of times the third set register set becomes the first register set is 80 times.

22. The system of claim 1, wherein the pulsed bus is a single wire bidirectional bus or a multiple wire bidirectional bus.

23. The system of claim 1, wherein the pulsed bus comprises a long pulse and a short pulse and wherein the long pulse is longer in time than the short pulse.

24. The system of claim 23, wherein the long pulse is at least twice as long as the short pulse.

25. The system of claim 23, wherein the pulsed bus is adapted to operate at a regular speed, a high speed and combinations thereof.

26. The system of claim 25, wherein each pulse in high speed is produced faster than an equivalent pulse in regular speed.

27. A method for managing consumables used in an ink jet print system, wherein the method comprises the steps of:
a. encoding a serial device for a printhead with a unique signature;
b. initializing the serial device to include data selected from the group consisting of consumable type information, ink type information, ink color information, original equipment manufacturer information, printhead TSR values, ink usage, and combinations thereof;
c. delivering the printhead to a customer's facility;
d. communicating periodically with the serial device at the customer's facility to track ink consumption through the printhead wherein the communicating includes authenticating the serial device by verifying the unique signature within the serial device using hardware and firmware within the ink jet print system;
e. tracking the ink consumption and comparing the ink consumption to a first threshold level;
f. providing a first message to an operator when the first threshold level is reached; and
g. providing a second message to the operator when a second threshold level is reached, thereby indicating that the operator should replace the printhead.

28. The method of claim 27, wherein the step of tracking the ink consumption is performed by counting ink drops.

29. A method for preventing unauthorized duplication and use of an ink jet print system, wherein the method comprises the steps of::
a. encoding a serial device for a printhead with a unique signature;
b. initializing the serial device to include data selected from the group consisting of consumable type information, ink type information, ink color information, original equipment manufacturer information, printhead TSR values, ink usage, and combinations thereof;
c. delivering the printhead to a customer's facility;
d. communicating periodically with the serial device at the customer's facility to track ink consumption through the printhead wherein the communicating includes authenticating the serial device by verifying the unique signature within the serial device using hardware and firmware within the ink jet print system;
e. tracking the ink consumption and comparing the ink consumption to a first threshold level;
f. providing a first message to an operator at the customer's facility that the first threshold level is reached; and
g. providing a second message to the operator when a second threshold level is reached, thereby indicating that the operator should replace the printhead.

30. The method of claim 29, wherein the step of tracking the ink consumption is performed by counting ink drops.
